(19) United States
(12) Patent Application Publication
(10) Pub. No.: US 2024/0105024 A1
(43) Pub. Date: Mar. 28, 2024

(54) SYSTEM FOR WAGERING ON EVENT OUTCOMES BASED ON TWO TIMINGS DURING AN EVENT

(71) Applicant: AdrenalineIP, Washington, DC (US)

(72) Inventors: Casey Alexander HUKE, Washington, DC (US); John CRONIN, Jericho, VT (US); Michael D'ANDREA, Burlington, VT (US); Joseph W. BEYERS, Saratoga, CA (US)

(73) Assignee: AdrenalineIP, Washington, DC (US)

(21) Appl. No.: 18/519,441

(22) Filed: Nov. 27, 2023

Related U.S. Application Data
(63) Continuation-in-part of application No. 17/718,591, filed on Apr. 12, 2022, now abandoned.
(60) Provisional application No. 63/253,223, filed on Oct. 7, 2021.

(51) Int. Cl. G07F 17/32; G06N 20/00

(52) U.S. Cl. CPC G07F 17/3288; G06N 20/00; G07F 17/323; G07F 17/3269

(57) ABSTRACT

A system for wagering on event outcomes based on two timings during an event can include determining a first timing of an event and a plurality of possible future states of the event based upon a second timing of the event. Then the system may determine a probability of occurrence for each of the plurality of possible future states based on probability information. Then the system may determine odds for betting that a first one of the pluralities of possible future states will occur. Then the system may present a plurality of users at a plurality of corresponding computer interfaces information indicating an opportunity to place a bet at the determined odds that the first possible future state will occur, the plurality of computer interfaces being in networked communication with the at least one processor.

### CROSS-REFERENCE TO RELATED APPLICATIONS

The present patent application is a continuation-in-part of U.S. patent application Ser. No. 17/718,591, filed on Apr. 12, 2022, which claims benefit and priority to U.S. Provisional Patent Application No. 63/253,223 filed on Oct. 7, 2021, which is hereby incorporated by reference into the present disclosure.

### FIELD

The present disclosure generally relates to in-play wagering on live sporting events.

### BACKGROUND

Currently, on wagering applications and wagering platforms, users are limited in their wagering options to only wager on games' outcomes or game-defined time periods.

Also, users are limited in the types of wagering options available once an event has started.

Lastly, users are routinely offered variations of the same types of wagering options from various wagering applications and wagering platforms enticing users to place a wager.

Thus, there is a need in the prior art to provide users with wagering options during an event.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a system for wagering on event outcomes based on two timings during an event, according to an embodiment.

FIG. 2 illustrates a base module, according to an embodiment.

FIG. 3 illustrates an example of OCM Object Content, according to an embodiment.

FIG. 4 illustrates an example 2 of OCM Object Content, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. The described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, and/or hit performed by a participant in a sporting event. In some embodiments, an action may be a strategic decision made by a participant in the sporting event, such as a player, coach, management, etc. In some embodiments, an action may be a penalty, foul, or other type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity based on the outcome of a future event, such as the results of a game or event. It may be understood that non-monetary items may be the subject of a “bet” or “wager” as well, such as points or anything else that can be quantified for a “bet” or “wager.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be made for certain amount or for a future time. A “bet” or “wager” can be made for being able to answer a question correctly. A “bet” or “wager” can be made within a certain period. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain to place bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example, up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sportsbook has reduced its betting limits, usually because of weather or the uncertain status of injured players, is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides,” “favorite,” “chalk,” “circled game,” “laying the points price,” “dog,” and “underdog” can be integrated into the embodiments in a variety of manners.

The “money line” refers to the odds expressed in terms of money. With money odds, whenever there is a minus (−), the player “lays” or is “laying” that amount to win (for example, $100); where there is a plus (+), the player wins that amount for every $100 wagered. A “straight bet” refers to an individual wager on a game or event that will be determined by a point spread or money line. The term “straight-up” means winning the game without any regard to the “point spread,” a “money-line” bet. “Money line,” “straight bet,” and “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread.” A handicap of the “point spread” value is given to the favorite team so bettors can choose sides at equal odds. “Cover the spread” means that a favorite wins an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread.” The “opening line” means the earliest line posted for a particular sporting event or game. The term “pick” or “pick ‘em” refers to a game when neither team is favored in an event or game. “Line,” “cover the spread,” “cover,” “tie,” “pick,” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. The event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total,” “over,” and “under” can be integrated into the embodiments in a variety of manners.

A “parlay” is a single bet that links together two or more wagers; to win the bet, the player must win all the wagers in the “parlay.” If the player loses one wager, the player loses the entire bet. However, if they win all the wagers in the “parlay,” the player receives a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay,” “round robin,” “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games, and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events. Typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both pitchers scheduled to start a game start. If they do not, the bet is deemed “no action” and refunded. The “run line” in baseball refers to a spread used instead of the money line. “Listed pitchers,” “no action,” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle,” “juice,” vigorish,” “vig,” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individuals that would deploy, for fees, and may be part of, or perform, various system elements or method steps in the embodiments.

Managed service user interface service is a service that can help customers (1) manage third parties, (2) develop the web, (3) perform data analytics, (4) connect thru application program interfaces and (4) track and report on player behaviors. A managed service user interface can be integrated into the embodiments in a variety of manners.

Managed service risk management service are services that assist customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling, and (4) customer service assistance. These managed service compliance services can be integrated into the embodiments in a variety of manners.

Managed service pricing and trading service is a service that helps customers with (1) official data feeds, (2) data visualization, and (3) land based on property digital signage. These managed service pricing and trading services can be integrated into the embodiments in a variety of manners.

Managed service and technology platforms are services that help customers with (1) web hosting, (2) IT support, and (3) player account platform support. These managed service and technology platform services can be integrated into the embodiments in a variety of manners.

Managed service and marketing support services are services that help customers (1) acquire and retain clients and users, (2) provide for bonusing options, and (3) develop press release content generation. These managed service and marketing support services can be integrated into the embodiments in a variety of manners.

Payment processing services are services that help customers with (1) account auditing and (2) withdrawal processing to meet standards for speed and accuracy. Further, these services can provide for integration of global and local payment methods. These payment processing services can be integrated into the embodiments in a variety of manners.

Engaging promotions may allow customers to treat players to free bets, odds boosts, enhanced access, and flexible cashback to boost lifetime value. Engaging promotions can be integrated into the embodiments in a variety of manners.

“Cash out” or “pay out” or “payout” may allow customers to make available, on singles bets or accumulated bets with a partial cash out where each operator can control payouts by always managing commission and availability. The “cash out” or “pay out” or “payout” can be integrated into the embodiments in a variety of manners, including both monetary and non-monetary payouts, such as points, prizes, promotional or discount codes, and the like.

“Customized betting” may allow customers to have tailored personalized betting experiences with sophisticated tracking and analysis of players' behavior. “Customized betting” can be integrated into the embodiments in a variety of manners.

Kiosks are devices that offer interactions with customers, clients, and users with a wide range of modular solutions for both retail and online sports gaming. Kiosks can be integrated into the embodiments in a variety of manners.

Business Applications are an integrated suite of tools for customers to manage the everyday activities that drive sales, profit, and growth by creating and delivering actionable insights on performance to help customers to manage the sports gaming. Business Applications can be integrated into the embodiments in a variety of manners.

State-based integration may allow for a given sports gambling game to be modified by states in the United States or other countries, based upon the state the player is in, mobile phone, or other geolocation identification means. State-based integration can be integrated into the embodiments in a variety of manners.

Game Configurator may allow for configuration of customer operators to have the opportunity to apply various chosen or newly created business rules on the game as well as to parametrize risk management. The Game Configurator can be integrated into the embodiments in a variety of manners.

“Fantasy sports connectors” are software connectors between method steps or system elements in the embodiments that can integrate fantasy sports. Fantasy sports allow a competition in which participants select imaginary teams from among the players in a league and score points according to the actual performance of their players. For example, if a player in fantasy sports is playing at a given real-time sport, odds could be changed in the real-time sports for that player.

Software as a service (or SaaS) is a software delivery and licensing method in which software is accessed online via a subscription rather than bought and installed on individual computers. Software as a service can be integrated into the embodiments in a variety of manners.

Synchronization of screens means synchronizing bets and results between devices, such as TV and mobile, PC, and wearables. Synchronization of screens can be integrated into the embodiments in a variety of manners.

Automatic content recognition (ACR) is an identification technology that recognizes content played on a media device or present in a media file. Devices containing ACR support enable users to quickly obtain additional information about the content they see without any user-based input or search efforts. A short media clip (audio, video, or both) may be selected to start the recognition. This clip could be selected from within a media file or recorded by a device. Through algorithms such as fingerprinting, information from the actual perceptual content is taken and compared to a database of reference fingerprints, wherein each reference fingerprint corresponds with a known recorded work. A database may contain metadata about the work and associated information, including complementary media. If the media clip's fingerprint is matched, the identification software returns the corresponding metadata to the client application. For example, during an in-play sports game, a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet”—which is a computer-generated data point—is placed above the player that is bet on. Augmented reality can be integrated into the embodiments in a variety of manners.

A betting exchange system may be a platform that matches up users who wish to take opposite sides in a bet. Users may “back” or “lay” wagers on the outcome of an event or a portion of the event. Each wager on a betting exchange may involve two bets, one backing, and one laying. Back betting, or “backing” a selection, is to wager that the outcome will occur. Lay betting, or “laying” a selection, is to wager that the outcome will not occur. Users may then trade those positions up until the point that the wagering market closes, and the wagers are paid out. The value of a wager may increase or decrease based as a sporting event progresses. Exchanges may allow users to cash out of their position before the market for a wager closes by selling that wager at the current price to another user on the exchange.

Betting exchange systems may allow users to wager on what is not going to happen with “lay” wagers. Often, users are more likely to win money by betting on what is not going to happen. Take the correct score markets in soccer, for example. Consistently picking the exact score in a game is impossible. One may get it right every now and then, but it just comes down to luck due to the number of options from which to choose. There are nine potential score outcomes even if we could rule out either team scoring more than two goals.

Betting exchange systems may allow wagers involving more than two users as exchange betting may allow for one lay bet to be backed by multiple users who each back a portion of the lay bet. Those wagers may be at different odds. For example, a first user may want to back Team A to win for $20. There may be a second user, or users, who want to lay $10 on Team A not to win at 2 to 1 odds. There may also be a third user, or users, who want to lay $10 on Team A not to win at 3 to 1 odds. The first user may back team A to win for $10 at the best available odds, in this case, 2 to 1. If the first user wants to back team A to win for $20, they will need to back ten dollars at 2 to 1 against the second user and back the other ten dollars against the third user at 3 to 1. This combination of wagers is the equivalent backing Team A to win for $20 at 2.5 to 1 odds.

Betting exchange systems may not take on the risk of any given wager as a traditional sportsbook would because the exchange users set the odds. Removing the risk to the wagering platform may allow users to get more value out of a wager by paying less to the exchange that does not have to take on the risk that a sportsbook must price into each wager. There may not be an inherent limit to the stakes or odds that a user of a betting exchange can propose. Betting exchange systems may derive revenue from wagers differently than traditional sportsbooks. Revenue may be based on the volume of wagers and trades on their platform, removing the results of the wager immaterial to the betting exchange system operation. Betting exchange systems may not lay bets themselves but instead might rely on users to offer up wagers. The betting exchange system's role may then be to facilitate the exchange of wager terms, trades of wagers, and settlement of wagers.

Betting exchange systems may not tend to limit or ban successful users the way traditional sportsbooks do. Betting exchange systems may not limit or ban successful users because there is no impact to the betting exchange system from a user's success. A successful user needs only to find someone to take the other side of their wager. A betting exchange system benefits from the increased liquidity brought to markets by successful gamblers.

Betting exchange systems may not limit the wagers they can offer. A traditional sportsbook may only offer wagers on which they have calculated odds. Users of a betting exchange system may create their own markets for any outcome and odds that have at least one user to back and at least one user to lay for a given outcome. Users may also be able to wager at a different price than the market price. For example, if a user is confident the price on a team they want to back is going to drift to a bigger price due to team news, they can place a request and set a higher price than is currently available. This may prompt another user to think they are wrong about their estimation and be prepared to match their bet at the bigger price.

Betting exchange systems may present information related to the exchange and potential wagers to back or lay in several different ways. Some betting exchange systems may use a standard or grid interface that puts the back and lay options laid out left to right, with the prices getting higher as you move away from the center. The amount of money or action at a given back or lay price may often be displayed. Some betting exchange systems may offer an option to back all or lay all. This option may allow a user to back or lay an outcome at multiple different prices. A user may not need to back all or lay all to wager at multiple prices on a given outcome.

A “ladder” interface may be a view in which the full market depth of a market on a betting exchange system is shown, along with the values associated with that price (volume already traded, amounts available, etc.). This type of interface may enable a user to see where the market has been and help them evaluate where it might be heading in the short term. Users may define a default “stake” or wager amount that, once defined, may allow the user to place orders immediately with a single click on the back or lay option at the price at which the user wants to enter the market. Users may remove their stake in the same fashion if another user has not yet accepted the stake. Ladder interfaces may allow users to place many trades in a short time. This trading volume may allow users to win, not only if their selection is successful, but by hedging their position across all possible outcomes. Each price increment (tick) on the ladder may display to the user their financial position if they closed at that point. Some betting exchange systems may show a graphical representation of where the selection has been matched. Others may show the user where they are in the queue of contracts to be met. Third-party software providers may receive data from the betting exchange system through an API to allow users to customize their interface and functionality. These third-party software programs may also allow users to incorporate additional data feeds, such as a news feed related to the live sporting event, into the user's wagering interface.

A betting exchange system may offer users multiple ways to win. Users may be able to use automated bots to manage their betting activity. Users who lack the expertise to create bots may set up betting triggers that may automate certain betting behaviors when specific market prices are met. Users may engage in “position trading” wherein bets may be placed with the intent to sell them off, seeking to find opportunities in market swings. Betting exchanges may allow users “hedging” options that may incorporate one or more of these strategies to mitigate risk. Liquidity in betting exchange systems may be limited by regulations that restrict participants in an exchange bet. Therefore, a betting exchange system may take steps to maximize the amount of liquidity on their platform to ensure the most markets are available.

A betting exchange system may rely on liquidity to ensure market availability. Markets may only be available if there is someone to both back and lay that market. There may be fewer markets available on a betting exchange if fewer people offer odds, and fewer people offer odds if fewer people accept them. If the people are not offering odds and there is no traditional bookmaker to do it, their markets may not be created, and wagers may not be placed.

A machine learning (which could include or utilize large language modelling) betting system may be a system that incorporates machine learning into at least one step in the odds makings, market creation, user interface, or personalization of a sports wagering platform. Machine learning may leverage artificial intelligence to allow a computer algorithm to improve itself automatically over time without being explicitly programmed. Machine learning and AI are often discussed together, and the terms may sometimes used interchangeably, but they are not the same. An important distinction is that although all machine learning is AI, not all AI is machine learning. Machine learning algorithms may develop their framework for analyzing a data set through experience in using that data. Machine learning may help create models that can process and analyze large amounts of complex data to deliver accurate results. Machine learning may use models or mathematical representations of real-world processes. It may achieve this through examining features, measurable properties, and parameters of a data set. It may utilize a feature vector, or a set of multiple numeric features, as a training input for prediction purposes. An algorithm may take a set of data known as “training data” as input. The learning algorithm may find patterns in the input data and train the model for expected results (target). The output of the training process may be the machine learning model. Further, unlike a human mind, such examining, vectoring, training, and learning may be done via parallel processing, thus providing such systems to operate significantly faster and more efficiently than humans A model may then make a prediction when fed input data. The value that the machine learning model must predict is called the target or label. When excessively large amounts of data are fed to a machine learning algorithm, it may experience overfitting, a situation in which the algorithm may learn from noise and inaccurate data entries. Overfitting may result in incorrectly labeled data or in inaccurate predictions. An algorithm may experience underfitting when it fails to decipher the underlying trend in the input dataset because it does not fit the data well enough.

A machine learning betting system may measure error once the model is trained. New data may be fed to the model, and the outcome may be checked and categorized into one of four types of results: true positive, true negative false positive, and false negative. A true positive result may be when the model predicts a condition when the condition is present. A true negative result may be when the model does not predict a condition when it is absent. A false-positive result may be when the model predicts a condition when it is absent. A false negative may be when the model does not predict a condition when it is absent. The sum of false positives and false negatives may be the total error in the model. While an algorithm or hypothesis can fit well to a training set, it might fail when applied to another data set outside the training set. Determining if the algorithm is fit for new data may be performed by testing it with a set of new data. Generalization may refer to how well the model predicts outcomes for a new set of data. Noise must also be managed, and data parameters tested. A machine learning betting system may go through several cycles of training, validation, and testing until the error in the model is brought within an acceptable range.

A machine learning betting system may use one or more types of machine learning. Supervised machine learning algorithms can use data that has already been analyzed, by a person or another algorithm, to classify new data. Analyzing a known training dataset may allow a supervised machine learning algorithm to produce an inferred function to predict output values in the new data. As input data is fed into the model, it may change the weighing of characteristics until the model is fitted appropriately. This supervised learning may be part of cross-validation which may ensure that the model avoids overfitting or underfitting. Supervised learning may help organizations solve various real-world problems at scale, such as classifying spam in a separate email folder.

Supervised machine learning algorithms may be adept at dividing data into two categories (binary classification), choosing between more than two types of answers (multi-class classification), predicting continuous values (regression modeling), or combining the predictions of multiple machine learning models to produce an accurate prediction (ensembling). Some methods used in supervised learning may include neural networks, naïve Bayes, linear regression, logistic regression, random forest, support vector machine (SVM), and more. A supervised machine learning betting system may be provided a dataset of historical sporting events, the odds of various outcomes of those sporting events, and the action waged on those outcomes. It may use that data to predict the action on future outcomes by identifying similar historical outcomes. A machine learning betting system may utilize recommendation algorithms to learn user preferences for teams, players, sports, wagers, etc.

Unsupervised machine learning may analyze and cluster data that has not yet been analyzed to discover hidden patterns or groupings within the data without the need for a human to define the patterns or groupings. The ability of unsupervised machine learning algorithms to discover similarities and differences in information may be an ideal solution for exploratory data analysis, cross-selling strategies, customer segmentation, image, and pattern recognition. Most types of deep learning, including neural networks, may be unsupervised algorithms.

Unsupervised machine learning may be utilized in dimensionality reduction or the process of reducing the number of random variables under consideration by identifying a set of principal variables. Unsupervised machine learning may split datasets into groups based on similarity, also known as clustering. It may also engage in anomaly detection by identifying unusual data points in a data set. It may also identify items in a data set that frequently occur together, also known as association mining. Principal component analysis and singular value decomposition are two methods of dimensionality reduction that may be employed. Other algorithms used in unsupervised learning may include neural networks, k-means clustering, probabilistic clustering methods, and more.

A machine learning betting system may fall between a supervised machine learning algorithm and an unsupervised one. In these systems, an algorithm was trained with a smaller labeled dataset to identify features and classify a larger, unlabeled dataset. These types of algorithms may perform better when provided with labeled datasets. However, labeling can be time-consuming and expensive, which is where unsupervised learning can provide efficiency benefits. For example, a sportsbook may identify a cohort of users in a dataset who exhibit desirable behavior. A semi-supervised machine learning betting system may be used to identify other users in the cohort who are desirable.

Reinforcement learning is when data scientists teach a machine learning algorithm to complete a multi-step process with clearly defined rules. The algorithm is programmed to complete a task and is given positive and negative feedback or cues as it works out how to complete the task it has been given. The prescribed set of rules for accomplishing a distinct goal may allow the algorithm to learn and decide which steps to take along the way. This combination of rules along with positive and negative feedback may allow a reinforcement learning machine learning betting system to optimize the task over time. A machine learning betting system may utilize reinforcement learning to identify potential cheaters by recognizing a series of behaviors associated with undesirable player conduct, cheating, or fraud.

Some embodiments of this disclosure, illustrating all its features, will now be discussed in detail. It can be understood that the embodiments are intended to be open-ended in that an item or items used in the embodiments is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

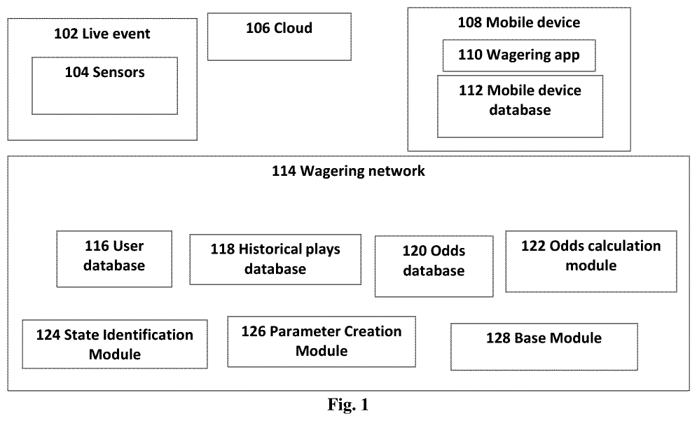

FIG. 1 is a system for wagering on event outcomes based on two timings during an event. This system may include a live event 102, for example, a sporting event such as a football, basketball, baseball, or hockey game, tennis match, golf tournament, eSports, or digital game, etc. The live event 102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 102, such as the score of an American football game or the run line in a baseball game, or a series of actions in the live event 102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 102 or at another location.

Further, embodiments may include a plurality of sensors 104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 106 may be communicatively coupled to a peer-to-peer wagering network 114, which may perform real-time analysis on the type of play and the result of the play. The cloud 106 may also be synchronized with game situational data such as the time of the game, the score, location on the field, weather conditions, and the like, which may affect the choice of play utilized. For example, in an exemplary embodiment, the cloud 106 may not receive data gathered from the sensors 104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and may be utilized in a situation where a paired wearable device employs the mobile device 108 for additional memory or computing power or connection to the internet.

Further, embodiments may include a wagering software application or a wagering app 110, which is a program that enables the user to place bets on individual plays in the live event 102, streams audio and video from the live event 102, and features the available wagers from the live event 102 on the mobile device 108. The wagering app 110 allows the user to interact with the wagering network 114 to place bets and provide payment/receive funds based on wager outcomes.

Further, embodiments may include a mobile device database 112 that may store some or all the user's data, the live event 102, or the user's interaction with the wagering network 114.

Further, embodiments may include the wagering network 114, which may perform real-time analysis on the type of play and the result of a play or action. The wagering network 114 (or the cloud 106) may also be synchronized with game situational data, such as the time of the game, the score, location on the field, weather conditions, and the like, which may affect the choice of play utilized. For example, in an exemplary embodiment, the wagering network 114 may not receive data gathered from the sensors 104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 116, which may contain data relevant to all users of the wagering network 114 and may include, but is not limited to, a user ID, a device identifier, a paired device identifier, wagering history, or wallet information for the user. The user database 116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 116 may contain betting lines and search queries. The user database 116 may be searched based on a search criterion received from the user. Each betting line may include but is not limited to, a plurality of betting attributes such as at least one of the following: the live event 102, a team, a player, an amount of wager, etc. The user database 116 may include, but is not limited to, information related to all the users involved in the live event 102. In one exemplary embodiment, the user database 116 may include information for generating a user authenticity report and a wagering verification report. Further, the user database 116 may be used to store user statistics like, but not limited to, the retention period for a particular user, frequency of wagers placed by a particular user, the average amount of wager placed by each user, etc.

Further, embodiments may include a historical plays database 118 that may contain play data for the type of sport being played in the live event 102. For example, in American Football, for optimal odds calculation, the historical play data may include metadata about the historical plays, such as time, location, weather, previous plays, opponent, physiological data, etc.

Further, embodiments may utilize an odds database 120—that may contain the odds calculated by an odds calculation module 122—to display the odds on the user's mobile device 108 and take bets from the user through the mobile device wagering app 110.

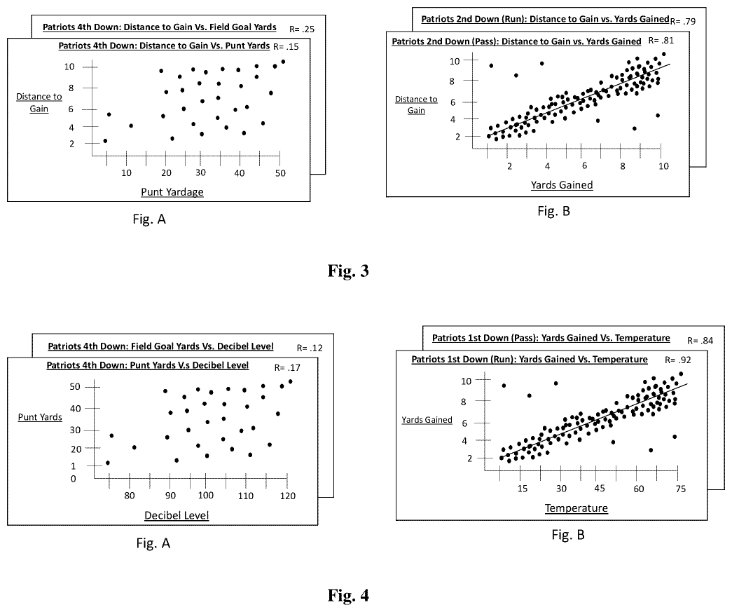

Further, embodiments may include the odds calculation module 122, which may utilize historical play data to calculate odds for in-play wagers. For example, the odds calculation module 122 may continuously poll for the data from the live event 102. The odds calculation module 122 may receive the data from the live event 102. The odds calculation module 122 may store the results data, or the results of the last action, in the historical play database 118, which may contain historical data of all previous actions. The odds calculation module 122 may filter the historical play database 118 on the team and down from the situational data. The first parameter of the historical plays database 118 may be selected, for example, the event. Then the odds calculation module 122 may perform correlations on the data. For example, the historical action database 130 may be filtered on the team, the players, the quarter, the down, and the distance to be gained. The first parameter may be selected, which in this example, the event, which may either be a pass or a run and the historical action database 130 may be filtered on the event being a pass. Then, correlations may be performed on the rest of the parameters: yards gained, temperature, decibel level, etc. In FIG. 3B, the graph may show the correlated data for the historical data involving the Patriots in the second quarter on second down with five yards to go and the action being a pass, which has a correlation coefficient of 0.81. The correlations may also be performed with the same filters and the next event, which is the action being a run shown in FIG. 3B and has a correlation coefficient of 0.79. It may be determined if the correlation coefficient is above a predetermined threshold, for example, 0.75, to determine if the data is highly correlated and deemed a relevant correlation. If the correlation is deemed highly relevant, then the correlation coefficient is extracted from the date. For example, the two correlation coefficients of 0.81 for a pass and 0.79 for a run are both extracted. If the correlations are not highly relevant, then then it may be determined if any parameters are remaining. Also, if the correlations were determined to be highly relevant, it may be determined if any parameters are remaining to perform correlations on. If there are additional parameters to have correlations performed, then the odds calculation module 122 may select the next parameter in the historic action database and return to performing correlations on the data. Once there are no remaining parameters to perform correlations on, the odds calculation module 122 may determine the difference between each of the extracted correlations. For example, the correlation coefficient for a pass is 0.81, and the correlation coefficient for a run is 0.79. The difference between the two correlation coefficients (0.81-0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendation database to compare the two correlation coefficient based on statistical significance as opposed to the difference of the two correlation coefficients. The difference between the two correlation coefficients, 0.02, may then be compared to the recommendation database. The recommendation database may contain various ranges of differences in correlations as well as the corresponding odds adjustment for those ranges. For example, the 0.02 difference of the two correlation coefficients may fall into the range +0-2 difference in correlations, which should have an odds adjustment of a 5% increase according to the recommendation database. The odds calculation module 122 may then extract the odds adjustment from the recommendation database. The extracted odds adjustment may be stored in an adjustment database. The odds calculation module 122 may compare the odds database 120 to the adjustment database. It may be determined whether there is a match in any of the wager IDs in the odds database 120 and the adjustment database. For example, the odds database 120 may contain all the current bet options for a user. The odds database 120 may contain a wager ID, event, time, quarter, wager, and odds for each bet option. The adjustment database may contain the wager ID and the percentage, either as an increase or decrease, that the odds should be adjusted. If there is a match between the odds database 120 and the adjustment database, then the odds in the odds database 120 may be adjusted by the percentage increase or decrease in the adjustment database, and the odds in the odds database 120 may be updated. For example, if the odds in the odds database 120 are −105 and the matched wager ID in the adjustment database is a 5% increase, then the updated odds in the odds database 120 should be −110. If there is a match, the odds may be adjusted based on the data stored in the adjustment database, and the new data may be stored in the odds database 120 over the old entry. If there are no matches, or, once the odds database 120 134 has been adjusted if there are matches, the odds calculation module 122 may offer the odds database 120 to the wagering app 110, allowing users to place bets on the wagers stored in the odds database 120. In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 122. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1−b2/Sb1−b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 122 may then extract an odds adjustment from the recommendation database. The extracted odds adjustment may be stored in the adjustment database. In some embodiments, the recommendations database may be used in the odds calculation module 122 to determine how the wager odds should be adjusted depending on the difference between the correlation coefficients of the correlated data points. The recommendations database may contain the difference in correlations and the odds adjustment. For example, in FIG. 3B there is a correlation coefficient for a Patriots 2nd down pass of 0.81 and a correlation coefficient for a Patriots 2nd run of 0.79, the difference between the two may be +0.02 when compared to the recommendation database the odds adjustment may be a 5% increase for a Patriots pass or otherwise identified as wager 201 in the adjustment database. In some embodiments, the difference in correlations may be the statistical significance of comparing the two correlation coefficients to determine how the odds should be adjusted. In some embodiments, the adjustment database may be used to adjust the wager odds of the odds database 120 If a wager should be adjusted. The adjustment database may contain the wager ID, which is used to match with the odds database 120 to adjust the odds of the correct wager.

Further, embodiments may include the state identification module 124, which may identify or otherwise define a state of an event. The state may comprise a particular status of a game, e.g., the players on the field, the count of the pitch, the inning, and other information. In some embodiments, several possible future states may be identified, and probability and odds may be determined for each possible future state. For example, in baseball, a state may be identified based on the following factors: number of outs, number of balls and strikes of the current batter, number of players on base, and the bases occupied. The inning may further identify the state, score, pitcher identity, batter identity, identities of fielders and any players on base, next batter(s) up, temperature, weather conditions, etc. Possible future states, for example, after a given pitch or at-bat, may be identified according to all the possible outcomes of the pitch, such as several runs, new players' positions on base, another out, etc. The state identification module 124 may also update the state of an event based on event information received from the live event 102. For instance, the state identification module 124 may receive event information such as a video stream of an event or a text play-by-play of an event. The state identification module 124 may process the event information. For instance, the state identification module 124 may process video or other image information to determine information about the state of an event such as a game, e.g., the location of a football at the end of a play when a referee signals the end of the play, whether a football carrier crossed a first down marker, whether a player stepped out of bounds, whether a ball hit by a batter was hit out of the park within the “fair” territory, whether a tennis ball hits the net or lands in “out” territory, etc. Accordingly, the state identification module 124 may automatically determine information related to performance parameters and outcomes, for example, whether a batter was struck out or whether a quarterback threw an interception. In some embodiments, state identification module 124 may reconcile identified states with another source of information related to an event. For instance, in some embodiments, the sensors 104, a gaming agent, etc., may interact with state identification module 124 to define states, correct any errors in automatically determined states, and provide additional event information. For instance, the sensors 104, a gaming agent, etc., may note that a flag was called on a play after state identification module 124 may determine that a touchdown was scored during the play. In some embodiments, the state identification module 124 may reconcile information determined about a state with an “official” source of state information. For instance, an official umpire who referees a game may be an “official” source of information, such that a call made by a referee concerning whether a ball was a ball may be controlling regardless of whether the state identification module 124 may determine that a ball crossed a batter's strike zone. Accordingly, the state identification module 124 may interact with the umpire to determine official “calls” in the game, and this information may be used to update the event's state. In some embodiments, referees may enter state information, such as “ball” or “strike,” on a device that communicates directly with the state identification module 124 so that the state identification module 124 may update state information accurately. Information about states may be communicated to the wagering network 114, wagering app 110, or users. It may also be used to determine initial states and possible outcomes of a performance parameter and to determine or update probabilities associated with the outcomes. In some embodiments, the state identification module 124 may automatically identify event states and state changes, such as betting outcomes. For instance, the state identification module 124 may analyze one or more data sources to automatically identify an event state, such as an outcome of a betting event. For instance, the state identification module 124 may use a variety of sources to determine and/or confirm that a tennis player has scored a point, such as image processing software that analyzes a live video feed of the match; “play-by-play” information from a data feed; and a website that outputs the score of a game in substantially real-time. The state identification module 124 may analyze a video feed of a live tennis match to identify whether a tennis ball landed “in” or “out” on a player's side of the court. The state identification module 124 may also review “play-by-play” information from a data feed indicating that a tennis point has been scored by the player. In some embodiments, a human operator may determine the outcome of a betting event. For instance, the human operator may watch the live event, for example, live in person or via live television broadcast. In some embodiments, a human operator may determine the outcome of a betting event and then cause the system to settle bets based on the determined outcome. In this way, the bettors will have immediate feedback.

Further, embodiments may include a base module 128, which may receive pre-event information about an event. The base module 128 may send the pre-event information to one or more users. The base module 128 may receive information about the event during the event. Then the base module 128 may send the game information to one or more users. The base module 128 may define a performance parameter. For example, the performance parameter may be created by the parameter creation module 126. The performance parameter may be created based on the system's performance categories, variables, metrics, and other event or performance information. For example, the parameter creation module 126 may allow the system to define a performance parameter or a plurality of performance parameters. The base module 128 may determine the state information relating to a performance parameter. The state information may comprise any status or historical information about the event. In some embodiments, the state identification module 124 may determine the state information relating to a performance parameter. The base module 128 may identify a first timing associated with a set of possible future states associated with a performance parameter. The base module 128 may determine statistics associated with an outcome or type of outcome. The base module 128 may determine the probabilities and odds associated with one or more possible outcomes. In some embodiments, the probabilities may be received or calculated from a database of statistical information or probabilities. A third party may maintain the database. In some embodiments, the probabilities and odds associated with one or more possible outcomes may be determined by the odds calculation module 122. Then a user may request information relevant to a wager from the base module 128. The base module 128 may provide wager information. A user may select a wager. The user may confirm a wager. The base module 128 may close wagers for a particular event or wagering market, such as after a first timing for a particular in-game event and after the second timing for a particular in-game event has been completed. The base module 128 may receive real-time information about the state of an event. The base module 128 may identify an outcome of an event, such as an event that is the subject of a wager. For example, the base module 128 may determine an actual state among the possible future states. For example, the base module 128 may determine that the New England Patriots offensive drive resulted in a touchdown based on a source of event information. The base module 128 may then resolve all bets related to the associated wagering market. For example, the base module 128 may issue an appropriate payout to any winning betters and issue notifications to those who had losing bets. In some embodiments, the wagering network 114 may close, payout, and notify the users of winning wagers. In some embodiments, users may keep a wagering account that may contain an amount for wagering. Users may continue making wagers until the account is depleted or otherwise unavailable for further wagers.

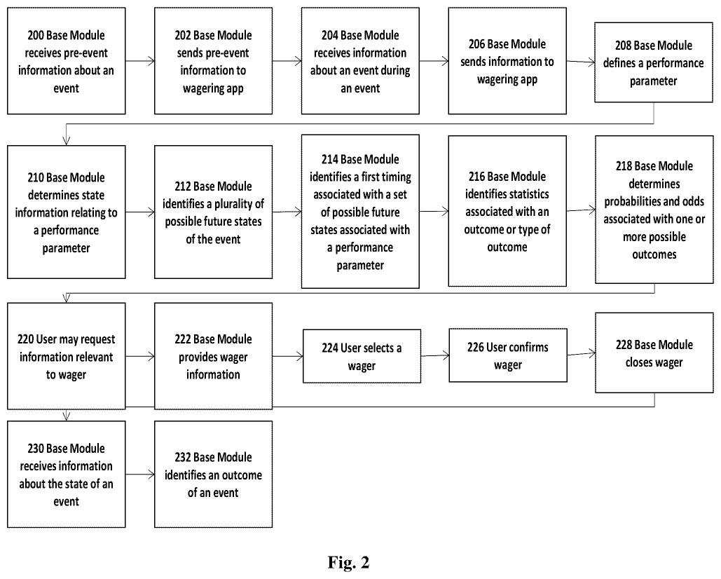

FIG. 2 illustrates the base module 128. The process may begin with the base module 128 receiving, at step 200, pre-event information about an event. For example, the base module 128 may receive from a data feed information about two teams playing in a game, such as a team roster, batting line-up (baseball), starting offensive line (football), an injury report for any potentially injured players, a game start time, and other information. The information may be downloaded or otherwise received from any source, such as a league or team website, press release, ESPN™, SportsRadar, or other sources of event information. The base module 128 may send, at step 202, the pre-event information to the wagering app and one or more users. For example, the game information, such as live video footage of a sporting event, may be displayed to the user on a television or computer monitor, radio, mobile phone, or other output devices. In some embodiments, the information may be displayed on a device capable of receiving user inputs, such as a mobile device 108, smartphone, touch-sensitive display device, etc. The display device may be operable to accept user inputs, such as selecting various betting options on a touch-sensitive display. The base module 128 may receive, at step 204, information about the event during the event. For example, the system may receive a data feed or a live broadcast. Then the base module 128 may send, at step 206, the game information to the wagering app and one or more users. For example, the information may be sent to users and gaming agents. For example, the game information, such as live video footage of a sporting event, may be displayed to the user on a television or computer monitor, radio, mobile phone, or other output devices. In some embodiments, the information may be displayed on a device capable of receiving user inputs, such as a mobile device 108, smartphone, touch-sensitive display device, etc. The display device may be operable to accept user inputs, such as selecting from among various betting options on a touch-sensitive display. The base module 128 may define, at step 208, a performance parameter. For example, the performance parameter may be created by the parameter creation module 126. The performance parameter may be created based on the system's performance categories, variables, metrics, and other event or performance information. For example, the parameter creation module 126 may allow the system to define a performance parameter or a plurality of performance parameters. For example, the performance parameter may be the number of batters that pitcher Chris Sale strikes out in the second inning of the Boston Red Sox vs. New York Yankees event, the number of jump shots that Kevin Durant attempts in the third quarter of the Brooklyn Nets vs. the Toronto Raptors event, the number of saves that Tuukka Rask will have in the last ten minutes of the second period in the Boston Bruins vs. New York Rangers event, the number of passing yards Patrick Mahomes will have in the first offensive drive in the third quarter in the Kansas City Chiefs vs. Las Vegas Raiders event, etc. The system may have predefined performance parameters that are selected by the system and offered to the users through the wagering app 110 to allow the users to place wagers. The parameter creation module 126 may select the predefined performance parameters through a combination of selecting the wager type and determining if the selected wager type has sufficient data to determine wager odds and determine if the wager if offered, would have users place a wager on the wager. For example, the parameter creation module 126 may select a first wager type, such as the number of pitches thrown in an inning for a pitcher in an event. Then the parameter creation module 126, through the process described in the odds calculation module 122, may determine if the selected wager type would have sufficient data by filtering the historical plays database 118 on the parameters of the wager, such as the pitcher, the inning, the opponent, etc. If sufficient data remains in the historical plays database 118, then the parameter creation module 126 may determine if users would place a wager on the wager if it were offered on the wagering app 110 through the wagering network 114. For example, the parameter creation module 126 may determine if a user would place a wager on the potentially offered wager by determining if it is a popular market, such as how many users have placed a wager on a similar wager type in the past by filtering the user database 116 on the wager type and if a predetermined percentage of the total number of users have placed a wager on the wager type then the wager may be offered on the wagering app 110 through the wagering network 114. In some embodiments, the wager type may result from a single play in American football games, baseball games, basketball games, etc. For example, if the offensive football team will run, pass, gain a predetermined number of yards, score a touchdown, turnover the football, such as a fumble or interception, make or miss a field goal, gain a first down, etc. if the defensive football team will stop the offensive team for negative yardage, force a turnover such as a fumble or interception, sack the quarterback, allow a first down, touchdown, field, prevent a first down, touchdown, field goal, etc. For example, in baseball, the result of the batter such as a single, double, triple, home run, strikeout, groundout, flyout, the location of a hit and the result of the hit, a stolen base, etc., the result of the pitcher, such as a strike, ball, strikeout, walk, allow a hit, etc., the result of the fielders such as an error, double play, a runner caught stealing, etc. In some embodiments, the determination of the parameter creation module 126 of determining if the users will place a wager on the selected wager type may be accomplished by the overall money wagered on the wager type, the number of users in the past wagering on the wager type, the overall revenue to the wagering network, etc. The base module 128 may determine, at step 210, the state information relating to a performance parameter. The state information may comprise any status or historical information about the event. In some embodiments, the state identification module 124 may determine the state information relating to a performance parameter. For example, based on a real-time data feed of a sporting event, the state identification module 124 may determine whether a sporting event has begun, the score, time remaining, balls and strikes of a specific batter, which players are currently on the field, and other state information described herein. The base module 128 may identify, at step 212, a plurality of possible future states of the event. The end states may (or may not) be mutually exclusive, and they may relate to a specific performance parameter or occurrence that happens during the event. The base module 128 may identify, at step 214, a first timing associated with a set of possible future states associated with a performance parameter. For instance, a first timing may be the beginning of an offensive drive for a football team, and the second timing may be when the offensive drive is completed, finished, or has a result, such as a touchdown, field goal, turnover, etc. The base module 128 may determine, at step 216, statistics associated with an outcome or type of outcome. For instance, the system may determine statistics associated with one or more performance parameters associated with a particular team or player (or other event entity), such as whether a particular player will get a single or a home run for a particular at-bat. The base module 128 may determine, at step 218, the probabilities and odds associated with one or more possible outcomes. In some embodiments, the probabilities may be received or calculated from a database of statistical information or probabilities. A third party may maintain the database. In some embodiments, the probabilities and odds associated with one or more possible outcomes may be determined by the odds calculation module 122. For example, the odds calculation module 122 may receive the data from the live event 102. The odds calculation module 122 may store the results data, or the results of the last action, in the historical play database 118, which may contain historical data of all previous actions. The odds calculation module 122 may filter the historical play database 118 on the team and down from the situational data. The first parameter of the historical plays database 118 may be selected, for example, the event. Then the odds calculation module 122 may perform correlations on the data. For example, the historical action database 130 may be filtered on the team, the players, the quarter, the down, and the distance to be gained. The first parameter may be selected, which in this example, the event, which may either be a pass or a run and the historical action database 130 may be filtered on the event being a pass. Then, correlations may be performed on the rest of the parameters: yards gained, temperature, decibel level, etc. In FIG. 3B, the graph may show the correlated data for the historical data involving the Patriots in the second quarter on second down with five yards to go and the action being a pass, which has a correlation coefficient of 0.81. The correlations may also be performed with the same filters and the next event, which is the action being a run which is also shown in FIG. 3B and has a correlation coefficient of 0.79. It may be determined if the correlation coefficient is above a predetermined threshold, for example, 0.75, to determine if the data is highly correlated and deemed a relevant correlation. If the correlation is deemed highly relevant, then the correlation coefficient is extracted from the date. For example, the two correlation coefficients of 0.81 for a pass and 0.79 for a run are both extracted. If the correlations are not highly relevant, then then it may be determined if any parameters are remaining. Also, if the correlations were determined to be highly relevant, it is also determined if any parameters are remaining to perform correlations on. If there are additional parameters to have correlations performed, then the odds calculation module 122 may select the next parameter in the historic action database and returns to performing correlations on the data. Once there are no remaining parameters to perform correlations on, the odds calculation module 122 may determine the difference between each of the extracted correlations. For example, the correlation coefficient for a pass is 0.81, and the correlation coefficient for a run is 0.79. The difference between the two correlation coefficients (0.81-0.79) is 0.02. In some embodiments, the difference may be calculated by using subtraction on the two correlation coefficients. In some embodiments, the two correlation coefficients may be compared by determining the statistical significance. The statistical significance, in an embodiment, can be determined by using the following formula: Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved may be used instead of the difference of the correlation coefficients in a recommendation database to compare the two correlation coefficient based on statistical significance as opposed to the difference of the two correlation coefficients. The difference between the two correlation coefficients, 0.02, may then be compared to the recommendation database. The recommendation database may contain various ranges of differences in correlations as well as the corresponding odds adjustment for those ranges. For example, the 0.02 difference of the two correlation coefficients fall into the range +0-2 difference in correlations, which should have an odds adjustment of 5% increase according to the recommendation database. The odds calculation module 122 may then extract the odds adjustment from the recommendation database. The extracted odds adjustment may be stored in an adjustment database. The odds calculation module 122 may compare the odds database 120 to the adjustment database. It may be determined whether there is a match in any of the wager IDs in the odds database 120 and the adjustment database. For example, the odds database 120 may contain a list of all the current bet options for a user. The odds database 120 may contain a wager ID, event, time, quarter, wager, and odds for each bet option. The adjustment database may contain the wager ID and the percentage, either as an increase or decrease, that the odds should be adjusted. If there is a match between the odds database 120 and the adjustment database, then the odds in the odds database 120 may be adjusted by the percentage increase or decrease in the adjustment database, and the odds in the odds database 120 may be updated. For example, if the odds in the odds database 120 are −105 and the matched wager ID in the adjustment database is a 5% increase, then the updated odds in the odds database 120 should be −110. If there is a match, the odds may be adjusted based on the data stored in the adjustment database, and the new data may be stored in the odds database 120 over the old entry. If there are no matches, or, once the odds database 120 134 has been adjusted if there are matches, the odds calculation module 122 may offer the odds database 120 to the wagering app 110, allowing users to place bets on the wagers stored in the odds database 120.

In other embodiments, it may be appreciated that the previous formula may be varied depending on a variety of reasons, for example, adjusting odds based on further factors or wagers, adjusting odds based on changing conditions or additional variables, or based on a desire to change wagering action. Additionally, in other example embodiments, one or more alternative equations may be utilized in the odds calculation module 122. One such equation could be Zobserved=(z1−z2)/(square root of [(1/N1−3)+(1/N2−3)], where z1 is the correlation coefficient of the first dataset, z2 is the correlation coefficient of the second dataset, N1 is the sample size of the first dataset, and N2 is the sample size of the second dataset, and the resulting Zobserved to compare the two correlation coefficient based on statistical significance as opposed to the difference of the two correlation coefficients. Another equation used may be Z=b1-b2/Sb1-b2 to compare the slopes of the datasets or may introduce any of a variety of additional variables, such as b1 is the slope of the first dataset, b2 is the slope for the second dataset, Sb1 is the standard error for the slope of the first dataset and Sb2 is the standard error for the slope of the second dataset. The results of calculations made by such equations may then be compared to the recommendation data, and the odds calculation module 122 may then extract an odds adjustment from the recommendation database. The extracted odds adjustment may be stored in the adjustment database.

In some embodiments, the recommendations database may be used in the odds calculation module 122 to determine how the wager odds should be adjusted depending on the difference between the correlation coefficients of the correlated data points. The recommendations database may contain the difference in correlations and the odds adjustment. For example, in FIG. 3B there is a correlation coefficient for a Patriots 2nd down pass of 0.81 and a correlation coefficient for a Patriots 2nd run of 0.79, the difference between the two may be +0.02 when compared to the recommendation database the odds adjustment may be a 5% increase for a Patriots pass or otherwise identified as wager 201 in the adjustment database. In some embodiments, the difference in correlations may be the statistical significance of comparing the two correlation coefficients to determine how the odds should be adjusted.

In some embodiments, the adjustment database may be used to adjust the wager odds of the odds database 120 If a wager should be adjusted. The adjustment database may contain the wager ID, which is used to match with the odds database 120 to adjust the odds of the correct wager. A user may request, at step 220, information relevant to a wager from the base module 128. For example, the user may request historical information, such as information about a player or team's past performance, such as with respect to a particular performance parameter like total yards and/or current performance, such as performance during the current game. The user may also request information about what bets are available and the odds for each. In some embodiments, a user may request information by selecting a particular player on a screen. For example, a user may touch a video image of a pitcher to request information about the pitcher's pitching record. In some embodiments, a user may select to bet that a pitcher will strike out a current batter by touching the image of the pitcher. The base module 128 may provide, at step 222, wager information. For example, the system may send a wager overlay at a user display device. The overlay may display wager options such as the various possible outcomes for which the user may wager, the odds for each, probabilities or statistics relating to the various outcomes, and any other information that may be relevant to a user wager. The user may select, at step 224, a wager. For example, the user may navigate a menu of wager options, such as a touch-sensitive display on a mobile phone. In some embodiments, a user may select the opposite side of a wager proposed by another user. The user may confirm, at step 226, a wager. For example, the user may wager that a particular batter will strikeout. A user's wager may be placed automatically or canceled in some embodiments, such as based on triggering conditions. The base module 128 may close, at step 228, wagers for a particular event or wagering market, such as after a first timing for a particular in-game event and after the second timing for a particular in-game event has been completed. For instance, the base module 128 may close wagering on a particular at-bat for J. D. Martinez before Martinez steps up to the plate to receive the first pitch, or after Martinez steps up to the plate but before the pitcher begins to throw the first pitch to Martinez. In some embodiments, the base module 128 may close wagers automatically, such as without human intervention. In some embodiments, a human operator may close the wagers. For example, the human operator who is watching the event, such as live-in person or via TV broadcast with minimal time delay, may cause the base module 128 to close wagers for a particular at-bat now immediately before the pitcher throws the first pitch, or at another appropriate moment. In circumstances where the base module 128 does not receive information about an occurrence, such as a batter stepping up to the plate, until after occurrence has taken place, for example, due to a 2-second delay in a television broadcast, a human operator may be in a better position to determine an optimal time for closing wagering for an event, such as the last possible moment before the beginning of the event. In some embodiments, the base module 128 may continue to allow wagers on the event, but the betting options may change during the event. For example, the base module 128 may continuously or periodically update the odds of various outcomes based on current in-game information. For example, the base module 128 may recalculate the odds of various at-bat outcomes after each pitch through the process described in the odds calculation module 122. For example, the base module 128 may determine that the odds that a batter strikes out increases after each strike, and the odds that the batter will get walked increase after each resulting pitch is a ball. In some embodiments, the base module 128 may hedge its exposure to one or more outcomes. The base module 128 may receive, at step 230, real-time information about the state of an event. The information may be received from any source of current event information, as discussed above. The real-time event state information may comprise real-time historical information about the event, such as information relating to the result of an event, such as a strikeout, information that might affect the probability of an outcome of an event, such as a mild injury to a quarterback, performance information, such as, number of yards gained by a particular running back during a particular play, the game time elapsed and remaining, and other event information. The base module 128 may identify, at step 232, an outcome of an event, such as an event that is the subject of a wager. For example, the base module 128 may determine an actual state among the possible future states. For example, the base module 128 may determine that the New England Patriots offensive drive resulted in a touchdown based on a source of event information. The base module 128 may then resolve all bets related to the associated wagering market. For example, the base module 128 may issue an appropriate payout to any winning betters and issue notifications to those who had losing bets. In some embodiments, the wagering network 114 may close, payout, and notify the users of winning wagers. In some embodiments, users may keep a wagering account that may contain an amount for wagering. Users may continue making wagers until the account is depleted or otherwise unavailable for further wagers.

FIG. 3A provides an illustration of an example of the odds calculation module 122 and the resulting correlations. In FIG. 3A, the data may be filtered by the team, down and quarter, and finding the various correlations with the team, down and quarter, and the various parameters such as the yards to gain, punt yardage, field goal yardage, etc. An example of non-correlated parameters with the team, down, and quarter and the yards to gain and punt yardage with a 15% (which is below the 75% threshold), therefore there is no correlation, and the next parameters may be correlated, unless there are no more parameters remaining.

FIG. 3B provides an illustration of an example of the odds calculation module 122 and the resulting correlations. In FIG. 3B, the data may be filtered by the team, down and quarter, and finding the various correlations with the team, down and quarter and the various parameters such as the event, yards to gain, yards gained, etc. An example of correlated parameters may be the live event 102 being a pass and the team, down, and quarter with an 81%, therefore there may be a correlation (since it is above the 75% threshold). The correlation coefficient may need to be extracted and compared with the other extracted correlation coefficient, which in this example is the event data where the event is a run, which is correlated at 79%. The difference between the two correlations may be compared to the recommendations database to determine if there is a need to adjust the odds. In this example, there is a 0.02 difference between the event being a pass and the event being a run, which means on second down in the second quarter, the New England Patriots are slightly more likely to throw a pass than to run the ball, and the odds may be adjusted 5% decrease to match the correlated data. Conversely, if the correlated data of run, 0.79, is compared to the correlated data of a pass, 0.81, the difference may be −0.02, and the odds may be adjusted by a 5% increase.

FIG. 4A provides an illustration for another example of the odds calculation module 122 and the resulting correlations. In FIG. 4A, the data that may be filtered by the team, down and quarter and finding the various correlations with the team, down and quarter and the various parameters such as the decibel level in the stadium, punt yardage, field goal yardage, etc. An example of non-correlated parameters with the team, down, and quarter and the decibel level in the stadium and punt yardage with a 17% (which is below the 75% threshold), therefore there is no correlation, and the next parameters may be correlated, unless there are no more parameters remaining.

FIG. 4B provides an illustration for another example of the odds calculation module 122 and the resulting correlations. In FIG. 4B, the data that may be filtered by the team, down and quarter and finding the various correlations with the team, down and quarter and the various parameters such as the event, temperature, yards gained, etc. An example of correlated parameters is with the event being a run and the team, down, and quarter with a 92%, therefore there is a correlation (since it is above the 75% threshold). The correlation coefficient may need to be extracted and compared with the other extracted correlation coefficient, which in this example is the event data where the event is a pass, which is correlated at 84%. The difference between the two correlations may be compared to the recommendations database to determine if there is a need to adjust the odds. In this example, there is a 0.08 difference between the event being a run and the event being a pass, which means on first down in the first quarter the New England Patriots are more likely to throw a run than to pass the ball, and the odds may be adjusted 15% decrease to match the correlated data. Conversely, if the correlated data of run, 0.84, is compared to the correlated data of a pass, 0.92, then the difference may be −0.08, and the odds may be adjusted by a 15% increase.

It may be further appreciated that, in the embodiments, it may be understood that the various modules may operate, process data, update, and transmit data in a parallel manner. For example, the parameter creation module 126 may function to generate appropriate parameters at the same time that the state identification module 124 is updating a current state or determining a next state. Similarly, odds calculation module 122 can perform the odds calculations as state identification module 124 updates and parameter creation module 126 generates further parameters Further, the base module 128 may be continuously operating in parallel with state identification module 124, parameter creation module 126, and odds calculation module to perform its functions and provide appropriate and continuous wagers through the wagering network 114.

The foregoing description and accompanying figures illustrate the principles, preferred embodiments, and modes of operation of the invention. However, the invention should not be construed as being limited to the embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for wagering on event outcomes using separate timings, comprising:
at least one processor; and
at least one memory having instructions stored thereon executed by the at least one processor to:
receive and send, to a wagering application, at least one pre-event information regarding a live event;
define at least one performance parameter;
determine at least one state information regarding the performance parameter;
identify at least one plurality of possible future states regarding the live event;
identify at least one first timing and second timing associated with the plurality of possible future states regarding the performance parameter;
identify at least one statistic regarding at least one type of outcome;
determine at least one of a probability and a set of odds associated with the type of outcome between the at least one of the at least one first timing and the second timing; and
receive at least one information request from the wagering application, and
send at least one information request to the wagering application,
wherein identification of the at least one first timing and second timing associated with the plurality of future states, identification of the at least one statistic regarding at least one type of outcome are performed in parallel.

2. The system for wagering on event outcomes using separate timings of claim 1, further comprising receiving at least one wager selection and at least one wager confirmation from the wagering application.

3. The system for wagering on event outcomes using separate timings of claim 1, wherein the processor further receives at least one state of event information and identifies at least one outcome of the live event.

4. The system for wagering on event outcomes using separate timings of claim 1, wherein the performance parameter is at least one of a system category, system variable, and a system metric.

5. The system for wagering on event outcomes using separate timings of claim 1, wherein the state information is at least one of a status or historical information regarding the performance parameter.

6. The system for wagering on event outcomes using separate timings of claim 1, wherein the plurality of future states is at least one of a status or outcome of the live event.

7. A betting exchange system for wagering on event outcomes using separate timings, comprising:
at least one processor; and
at least one memory having instructions stored thereon which, when executed by the at least one processor, direct the at least one processor to:
receive and send, to a wagering application, at least one pre-event information regarding a live event;
define at least one performance parameter;
determine at least one state information regarding the performance parameter;
identify one or more of a plurality of possible future states regarding the live event;
identify at least one first timing and second timing associated with the plurality of possible future states regarding the performance parameter;
identify at least one statistic regarding at least one type of outcome;
determine at least of a probability and a set of odds associated with the type of outcome;
display information regarding at least one opportunity for placement of at least one back bet or at least one lay bet; and
receive at least one information request from the wagering application and send at least one information request to the wagering application.

8. The betting exchange system for wagering on event outcomes using separate timings of claim 7, further comprising receiving, from the wagering application, at least one of a back wager selection or lay wager selection.

9. The betting exchange system for wagering on event outcomes using separate timings of claim 7, further comprising receiving at least one wager selection and at least one wager confirmation from the wagering application and issuing a payout from at least one first cohort of users to at least one second cohort of users.

10. A machine learning betting system for wagering on event outcomes using separate timings, comprising:
at least one processor; and
at least one memory having instructions stored thereon which, when executed by the at least one processor, direct the at least one processor to:
receive and send, to a wagering application, at least one pre-event information regarding a live event;
define, with machine learning, at least one performance parameter;
determine, with machine learning, at least one state information regarding the performance parameter;
identify at least one plurality of possible future states regarding the live event;
identify at least one first timing and second timing associated with the plurality of possible future states regarding the performance parameter;
identify, with machine learning at least one statistic regarding at least one type of outcome;
determine, with machine learning at least one set of probability and odds associated with the type of outcome; and
receive at least one information request from the wagering application and send at least one information request to the wagering application.

11. The machine learning betting system for wagering on event outcomes using separate timings of claim 10, wherein the machine learning is an unsupervised algorithm provided with at least one data set of historical play data for a live event.

12. The machine learning betting system for wagering on event outcomes using separate timings of claim 10, wherein the machine learning further comprises identifying at least one pattern in at least one sequence of historical plays.

13. The machine learning betting system for wagering on event outcomes using separate timings of claim 10, further comprising receiving at least one wager selection and at least one wager confirmation from the wagering application.

14. A method for wagering on event outcomes using separate timings, comprising:
receiving and sending at least one pre-event information to a wagering application;
defining at least one performance parameter;
determining at least one state information regarding the performance parameter;
identifying at least one plurality of possible future states regarding the live event;
identifying at least one first timing and second timing associated with the plurality of possible future states regarding the performance parameter;
identifying at least one statistic regarding at least one type of outcome;
determining at least one set of probability and odds associated with the type of outcome;
receiving at least one information request from the wagering application and send at least one information request to the wagering application; and
receiving at least one wager selection and at least one wager confirmation from the wagering application.
